(19) United States
(12) Patent Application Publication
(10) Pub. No.: US 2011/0028133 A1
(43) Pub. Date: Feb. 3, 2011

(54) Methods and Apparatus for Providing a Missed Call Alert to a Calling Party

(76) Inventor: Peter O. Roach, JR., Jacksonville, FL (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/847,627

(22) Filed: Jul. 30, 2010

Related U.S. Application Data
(60) Provisional application No. 61/273,103, filed on Jul. 30, 2009.

(51) Int. Cl. H04M 3/42

(52) U.S. Cl. 455/414.2

(57) ABSTRACT

Methods and apparatus are provided for capturing a missed call attempt and subsequently alerting the calling party when the called party is available to once again receive calls. The called party may be unavailable for any reason, including disconnection from the network and network congestion. Alerts may include advertising, offers for network service, offers for missed call related services, and options to opt out of missed call alerts. Alerts may also be customized by recipients so that when such recipients are not available, the customized alert is presented to the calling party.

### RELATED APPLICATIONS

The present application is related to the subject matter disclosed by and claims priority under 35 U.S.C. 119 to U.S. Provisional Patent Application Ser. No. 61/273,103, filed Jul. 30, 2009, entitled “Methods and Apparatus for providing A Missed Call Alert to a Calling Party”. Applicant hereby incorporates by reference the complete disclosure of said referenced provisional patent application.

### TECHNICAL FIELD

The present invention relates generally to a wired or wireless communications network and more particularly to the use and provisioning of a missed call alert to the party originating a call attempt.

### BACKGROUND

Current mobile communications networks sometimes store information pertaining to a missed call when a called party's mobile telephone is not attached to the network. The network then sends the called party an alert to indicate that an incoming call attempt was missed when the called party's mobile telephone reattaches itself to the network. This allows the called party to then determine if they desire to return the calling party's missed call. The problem with this scenario is the called party may not know the reason for the call, the urgency of the call, or other pertinent information regarding the call that originally triggered the calling party to attempt to originate a call to the called party. Since the calling party originated the call attempt, the calling party may have information that is unknown to the called party concerning the call attempt and may therefore have a higher sense of urgency to establish communications with the originally called party.

Further in a typical missed call alert situation where the called party is alerted to a missed call attempt, if the return call is originated due to a missed call alert, the call is an outbound call from the originally called party's network. In a calling-party-pays environment, where the calling party pays the airtime of the called party, the network originating the call typically retains only a small portion of the cost of the call. The majority of the cost of the call is typically passed onto the network receiving the call. In a calling-party-pays environment it may be seen as advantageous to find a method of triggering the originally calling party to place the call into the called network a subsequent time when the called party is available. This will enable the network of the originally called party to retain a much higher portion of the revenue for the call.

Further on many landline networks when dialing a number that is currently busy, instead of receiving a busy signal, it is possible to be alerted when the number is available to receive calls. This type of missed call alert is typically presented by calling the originally calling party and alerting them the originally called number is now available. This style of missed call alert does not however examine the network providing service to the originally called number to determine if the overall network is busy above a predetermined threshold. This style of missed call alert typically only looks at an individual line basis. Additionally the landline style of missed call alert does not examine whether the phone associated with the originally dialed number is currently attached to the network nor does the landline style missed call alert allow the originally calling party to be routed to voice mail or other subsequent call routing post depositing a missed call alert. The landline style missed call alert also does not allow for alternative phone routing in the event of a network busy condition or after attempting to reach a phone that is not currently attached to the network. The landline style missed call alert does not currently provide for advertising to the originally calling party. Finally, the landline style missed call alert does not currently allow the option of providing a data message to alert the originally calling party that the original called party is now available.

Accordingly, there is a need to overcome the limitations of the prior art when alerting the originally calling party to attempt to place the call again once it is determined that the originally called party is available.

### SUMMARY

The present invention solves the problems of the prior art by providing an apparatus and method for recognizing a network busy condition or a recognizing when a mobile phone is not attached to the network and then, when the network congestion is abated or the originally called phone is available on the network, allowing an alert to be routed to the mobile telephone of a calling party. This allows the original calling party to determine if the call should be reattempted. This manner of alerting, and subsequent call routing, also provides the original called network with mobile terminated interconnection revenues from an inbound call to the network. As described above, these mobile terminated interconnection revenues are typically much higher than mobile originated interconnection revenues. Missed call alerts may include advertising, offers for network service, offers for missed call related services, and options to opt out of missed call alerts. Alerts may also be customized by recipients so that when such recipients are not available, the customized alert is presented to the calling party. These and other aspects of the current disclosure are set forth below.

### BRIEF DESCRIPTION OF THE DRAWINGS

FIG. 1 is a network flow illustration of a missed call message alert to a calling party in a network utilizing an intelligent network trigger.

FIG. 2 is a network flow illustration of the handling and formatting missed call alert messages.

FIG. 3 is a flow diagram for handling and formatting missed call alert messages.

FIG. 4 is the continuation of a flow diagram for handling and formatting missed call alert messages.

FIG. 5 is a network flow illustration of the location derivation of originally called party.

### DETAILED DESCRIPTION

The present invention solves the problems of the prior art by providing an apparatus and method for recognizing a network busy condition or a recognizing when a mobile phone is not attached to the network and then, when the network congestion is abated or the originally called phone is available on the network, allowing an alert to be routed to the mobile telephone of a calling party. This allows the original calling party to determine if the call should be reattempted. This manner of alerting, and subsequent call routing, also provides the original called network with mobile terminated interconnection revenues from an inbound call to the network. As described above, these mobile terminated interconnection revenues are typically much higher than mobile originated interconnection revenues.

Yet another exemplary implementation of the invention, the incoming call attempt that is not answered can be detected by the use of an INAP (Intelligent Network Application Part) or a CAMEL (Customised Applications for Mobile networks Enhanced Logic) trigger. In order to recognize the missed call, the originally called party account can be provisioned with a feature such as call forward not available. This feature would be triggered by a call to a phone that was not available on the network; e.g., out of coverage or turned off. The call forwarding not available number may be a number that would cause an INAP trigger or alternatively a CAMEL trigger (example of an INAP trigger is an 800 or toll free call in the United States where the originating switch requests routing information from a separate database based on the number). The INAP or CAMEL trigger may be activated when a call was attempted to be routed to the designated number. When the INAP or CAMEL trigger is encountered, at a minimum, the calling party and called party information may be captured in the database where the INAP or CAMEL trigger was pointed (hereafter referred to as a “Call Back Platform” or “CBP”). The CBP may then place a marker in the home system HLR (Home Location Register) indicating that it had a message for the originally called party. When the HLR detected that the originally called party's mobile attached to the network the HLR would then signal the CBP that the mobile was again available. The CBP would then be programmed to send a signal to the originally calling party indicating that the originally called party was available.

Further it is possible to offer the same functionality when encountering a network busy condition. The mobile system may be programmed to send a message to a CBP indicating an incoming call encountered a network busy condition along with the calling number and the called number. The CBP may determine or estimate when the network is available and may send a message to the originally calling party indicating their call can be attempted again with a higher level of confidence the network is available.

In an exemplary implementation, the CBP may use the quantity of incoming missed call alert messages to determine, at least in part, the congestion level of the network. The CBP may also use other information in the missed call alert message to determine what portion of the network is busy; e.g., the CBP may parse messages from certain originating addresses (mobile switching centers or visitor location registers) to help determine a certain part of the network is busy. The CBP may further monitor the level of network busy messages to determine the level of congestion has dropped to a sufficient level to begin issuing call back messages to the originally calling party.

In a still further exemplary embodiment, an alert or announcement may be activated by the CBP in order to inform the calling party that a call back notification will be sent to them when the called party is available. This would enable the calling party to reliably expect to be alerted when the called party is available.

In another exemplary embodiment, the originally calling party may be provided with an option to enable missed call alert or not enable missed call alert for the called party line.

In a further exemplary implementation, the originally calling party may be provided with an announcement indicating the reason for the missed call; e.g., network congestion or mobile not attached to the network.

In yet another exemplary implementation, the originally called party may be alerted that call back alerts will be sent to originally calling party(ies) when the originally called party reattaches to the network (herein referred to as “Called Party Alert”).

In a further enhancement, the Called Party Alert may alternately consist of an audible alert such as an announcement, a text alert such as a short message, a data message displayed on the screen of the communications device, a graphic representation, web page, some combination of these methods, or any other similar medium.

In a still further enhancement, the Called Party Alert may contain data indicating the originally calling information. The original calling information may contain the identity of the originally calling party such as the account or phone number, email address, SKYPE™ identification, other instant message identification, name of the calling party, or other similar information. The originally calling party information may be retrieved from the signaling associated with the original call, may be minded from network databases, retrieved from directory information, retrieved from the directory information on the mobile phone, or the information may be retrieved from the personal information manager or phone book of the called party.

In yet another exemplary implementation, advertising may be associated with the message to the calling party. This advertising may be generated from the network operator of the called party or from a third party advertiser. The advertising may be in a visual or audible form and may also direct the calling party to web pages or other locations on the network associated with the advertiser.

In a still further enhancement, the advertising presented to the originally calling party may be at least in part determined by the demographic information associated with the called party. The theory behind associating called party demographic information with the message sent to the calling party, at least in part, is that individuals with similar demographics tend to associate with each other and a reasonable assumption may be made that the calling party's demographics may approximate or in some manner be determined by the called party's demographics.

In a still further enhancement, the advertising presented to the originally calling party may, at least in part, be determined by the time of day. For example, if the missed call alert is to be sent to the original calling party around lunch time the advertising information might be configured to contain restaurant information.

In still a further enhancement, the location information for the originally calling party may be used, at least in part, when configuring which advertising will be presented to the calling party. This location information may be obtained from more traditional sources such as GPS on the phone, network triangulation, or alternatively a crude location information might be determined from the response to the short message send routing information (SMSRI), a mobile station roaming number (MSRN), visitor location register identity or other similar information supplied by the calling party home network location register. The SMSRI, MSRN, or serving visitor location register may supply a rough geographic approximation and may be used target the advertising to the general area of the system.

In a still further enhancement, the serving network for the originally calling party may be used, at least in part, when configuring which advertising will be presented to the calling party. For example if the originally calling party is currently being served by a competing network the CBP may determine to provide advertisement showing the relative benefits of switching service to the serving network of the originally called party.

In a still further enhancement, numerous different methods (including those described above) may be used in conjunction with each other when determining which advertising will be presented to the calling party.

In yet a further enhancement a standard missed call alert may be provided to the called party when their phone reattaches to the network with the advertising described herein.

In still another exemplary implementation, the message to the originally calling party may be addressed in such a manner to make the message appear as if the message originated with the calling party; e.g., a short message may contain the header information indicating the message originated from the originally called mobile. This style of addressing the message may enable standard phone book look up for short messaging calling information to show the identity of the originally called party.

In a further exemplary implementation, the called party may preconfigure the message to be sent to the calling party. For example one called party may wish their message to read “I am back on my mobile—call when you have a moment” while another called party may wish their message to read “I'M BAAAAAACCCCCCCKKKKK” or another may wish to have “<NAME> is back on the network”.

In a further exemplary implementation, a billing record may be written for each call back to the original calling party. This billing record may be used as a settlement with other mobile operators in order to net out the cost of any signaling between the networks.

In a further exemplary implementation, a billing record may be written for each missed call alert to the originally calling party. This billing record may be used to rate or charge for advertising messages delivered, reconcile the effectiveness of individual messages, or for other charging/reconciliation purposes.

In still a further exemplary implementation, software on the originally called party's communications device may check with a database when first attaching with the network to determine if any missed call alerts are present. The software on the communications device may either be set to automatically determine how to treat the missed call event or to alert the user for them to determine how to treat a missed call event. The software on the communications device may alternatively be programmed to send a message directly to the original calling party, establish a voice communications path with the original calling party, and/or to alert the user of the communications device that a missed call is present.

In still a further exemplary implementation, the originally called party may choose to provide an alternative routing number in the event of the call from the originally calling number encountering a specific network condition. For example, the originally called party may configure the CBP to instruct the network to route the call to a special announcement or another telephone number. The originally called party may, for example, instruct the CBP to route a call that encountered a network busy condition to their landline office phone. Alternatively an originally called party that has less than adequate coverage from the mobile network in their home may instruct the CBP to route calls to their home number in the event of a call encountering a not available condition.

In still a further exemplary implementation, the alternative routing may be based, at least in part, on the time of day. This would allow the originally called party to route calls encountering a busy condition to their office phone during the day while routing to their home landline phone at night.

In still a further exemplary implementation, the CBP may provide a missed call alert to the originally calling party in conjunction with the alternative routing of a call.

In still a further exemplary embodiment, the alert message sent from the CBP to the originally calling party may contain an option to “opt in” or subscribe to the call alert service on the originally calling party's line. This “opt in” function may be achieved by providing an address that the user may send a short message (e.g., text message, email, etc.) to subscribe to the service, a hyperlink directed to a website that allows the user to opt in, a phone number to call to opt in, or other similar methods for the originally calling subscriber to opt in to the missed call alert service.

In still a further exemplary implementation, the alert message sent from the CBP to the originally calling party may contain an option to “opt out” or unsubscribe to the call alert service on the originally calling party's line. This “opt out” function may be achieved by providing an address that the user may send a short message (e.g., text message, email, etc.) to subscribe to the service, a hyperlink directed to a website that allows the user to opt in, a phone number to call to opt in, or other similar methods for the originally calling subscriber to opt out of the missed call alert service. The opt out may alternatively be for only messages related to the original called party's line or to all messages from the CBP or the network service provider.

In still a further exemplary implementation, a mobile network system provider may allow for a timeout period when handling a trigger such as an INAP or CAMEL trigger. In this embodiment the mobile network equipment responsible for handling the translation of the number may merely continue down the translation table until a match is achieved. In this case, a second translation may be inserted into the translation table to handle the call. The translation with the prefix to provide a trigger such as INAP or CAMEL would be a higher priority in the translation table; however, in the event the CBP did not respond in a predetermined time the translation would continue and then encounter a second translation event. An example might be the higher priority translation may result in the trigger prefix+the main number of the voice mail system while the second, lower priority translation may result in just the main number of the voice mail system. This would provide a default or back up routing in the event the CBP failed to provide a timely response to the initial trigger.

In a still further exemplary implementation, the CBP may determine if the originally calling party is calling from a mobile or a landline phone. If the call originated from a landline the CBP could optionally not continue processing the missed call alert or would process the missed call alert in a different manner from an originally calling party calling from a mobile network.

In a still further exemplary implementation, a missed call alert service disclosed herein may be implemented utilizing paired agents on handsets of the calling and called parties. These paired agents may communicate directly with each other over a data network to indicate when a call has been missed and to arrange a future communications between the parties.

Based on the foregoing, it can be seen that the present invention provides methods and apparatuses for providing an alert message to the original calling party when the called party attaches to the network or alternatively when a network busy condition is mitigated. Many other modifications, features, and embodiments of the present invention will become evident to those of skill in the art. It should be appreciated, therefore, that many of the presently disclosed aspects are described above by way of example only and are not intended as required or essential elements of the invention unless explicitly stated otherwise. Accordingly, it should be understood that the foregoing relates only to certain embodiments and that numerous changes may be made therein without departing from the spirit and scope of the invention as described in the detailed description and defined by the claims.

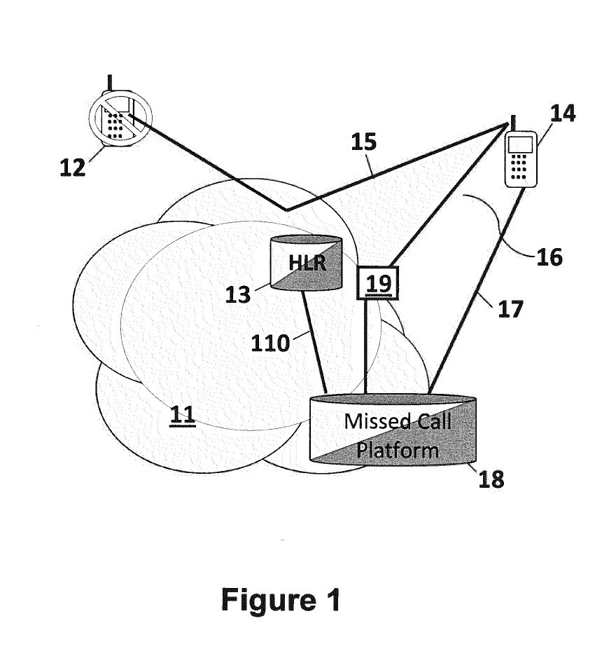

Referring now to FIG. 1, a wireless network 11 is illustrated with an incoming call attempt 16 from a mobile device 14. The network recognizes that mobile device 12 is not currently connected to the network 11 and is programmed to provide an intelligent network trigger 19. The intelligent network trigger 19 is programmed to request routing information from the missed call platform 18. The missed call platform 18 may instruct the network to tear down the call 16 or alternatively to continue routing as normal. The missed call platform 18 may record at least the calling party and the called party information. The missed call platform then may send a signal 110 to set a flag in the home location register (HLR) 13. This flag instructs HLR 13 to alert missed call platform 18 when mobile 12 attaches to the network 11. When mobile 12 attaches to the network HLR 13 may transmit signal 110 to the missed call platform 18 indicating that mobile 12 is now available. The missed call platform 18 may then transmit signal 17 to the original calling party 14 indicating that mobile 12 is now available. At this point the user of mobile 14 may choose to attempt to connect call 15 to mobile 12.

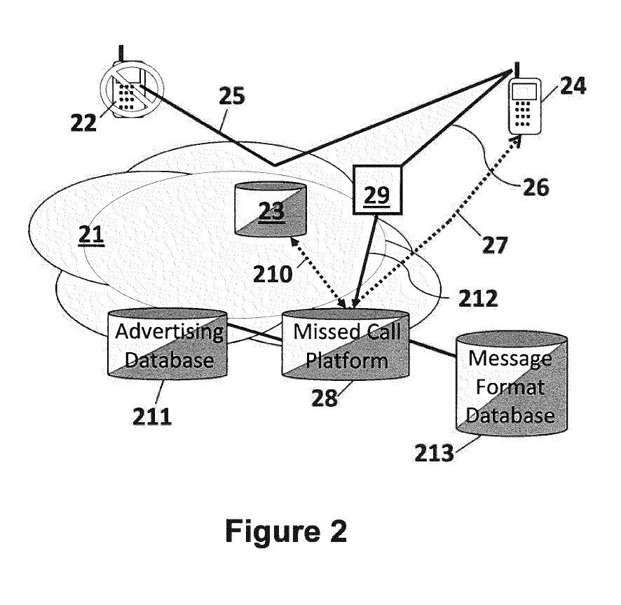

Turning now to FIG. 2, the originally calling party 24 may initiate a call 26 the originally called party's phone 22 that is not currently available on the network 21 due to congestion on the network 21, congestion on a portion of the network 21, out of coverage of network 21, or the phone 22 is turned off and not in communications with the network 21. The call 26 encounters some type of network trigger 29 causing a message 212 to be sent to the missed call platform 28. The missed call platform 28 may then instruct the network 21 to how to handle the call 26. In one implementation of the invention the missed call platform 28 receives a message 212 from trigger 29 that contains information indicating how to handle the call once message 212 is received by the missed call platform 28. One example of this handling information could be the voice mail number for the subscriber or account associated with phone 22. The missed call platform 28 receives at least information identifying the originally calling party 24 and the originally called party 22. In response to receiving the missed call message 212, the missed call platform 28 may instruct the network 21 how to further handle or route the inbound call 26. Provided the missed call platform 28 received the trigger message 212 due to the subscriber's phone 22 not being available to on the network 21, the missed call platform 28 then sends a message 210 to set a flag against the subscriber account in the subscriber database 23. This database 23 may alternatively be a home location register such as are used on 3GPP defined GSM networks or any other subscriber database that is designed to be alerted when a subscriber becomes available on the network 21. If however, the missed call platform 28 receives the message 212 due to at least a portion of the network encountering a busy condition, the missed call platform 28 may alternatively decide not to send a message 210 to set a flag in the subscriber database 23. In the event the missed call platform 28 decides not to set a flag in the subscriber database 23, the missed call platform 28 may alternatively choose to monitor traffic arriving at the missed call platform 28, or at a plurality of missed call platforms, to determine the loading or overloading within at least a portion of the network 21.

In the event the missed call platform 28 received the missed call message 212 due to the originally called phone 22 not being available to communicate with the network 21 due to reasons not related to the loading condition on the network, the missed call platform 28 may monitor the data link for a message 210 from the subscriber database 23 indicating the originally called party's phone 22 was again available to communicate with the network 21. If however, in the event the missed call platform 28 received the missed call message 212 due to at least a portion of the network 21 encountering a busy condition, the missed call platform can monitor the volume of incoming messages 212 caused by busy conditions. Optionally the missed call platform may monitor the volume of busy condition messages 212 across a period of time, the rate of reception of busy condition messages 212, or may have the network 21 inform the missed call platform 28 of the traffic load condition on at least a portion of the network 21. In the event the missed call message 212 was prompted by a network 21 busy condition, the missed call platform 28 can be programmed to wait until the message flow from the network 21 or the portion of the network 21 falls below a predetermined threshold before further processing the missed call event.

Once the answer message 210 was received from the flag in the subscriber database 23 or the missed call platform determined the traffic loading condition was appropriate to continue processing the missed call event, the missed call platform 28 can be programmed to send a message 27 to the originally calling party 24. Optionally prior to sending the message 27 to the originally calling party 24 the missed call platform 28 may check an opt out database to determine if the subscriber 24 has indicated they no longer choose to receive missed call alerts for the originally called phone 22 or for any subscribers. Alternatively this step of checking an opt out database may occur when the missed call platform 28 receives the original missed call message 212 or at another point in the processing of the missed call event.

Prior to sending the message 27 to the originally calling party 24 the missed call platform can determine if advertising is appropriate to attach to the message 27 to the originally calling party 24. If the missed call platform 28 determines that advertising is appropriate the missed call platform then looks up the appropriate advertising message in an advertising database 211. The missed call platform 28 may alternatively transmit information to the advertising database 211 to allow the advertising database to target advertising messages to the originally calling subscriber 24. The information transmitted by the missed call platform may include at least a portion of the address of the network, service provider, or network element currently serving the originally calling party. One method for the missed call platform to determine the network, service provider, or network element serving the originally calling party 24 is for the missed call platform 28 to send a routing request message to the subscriber database serving the originally calling number 24. This routing request message can result in a response from the subscriber database that includes routing information or message header information that may be used in better targeting advertising to the originally called party 24. Optionally the missed call platform 28 may consult a database that maps the subscriber number with the serving provider to help determine how to target advertising.

It is also possible for the missed call platform to consult a message format database 213 to determine how a response message transmitted to the originally called party 22 should be formatted. This database can optionally be updated by the user of phone 22 through the use of a web interface, a short messaged directed to a dedicated network address, or other similar manner

The message 27 to the originally calling party 24 may then be delivered. In many cases this message 27 would cause the user of the phone 24 to place an inbound call to the originally called subscriber 22 thus potentially triggering revenue to the operator of mobile network 21 provided the network utilizes calling party pays interconnection.

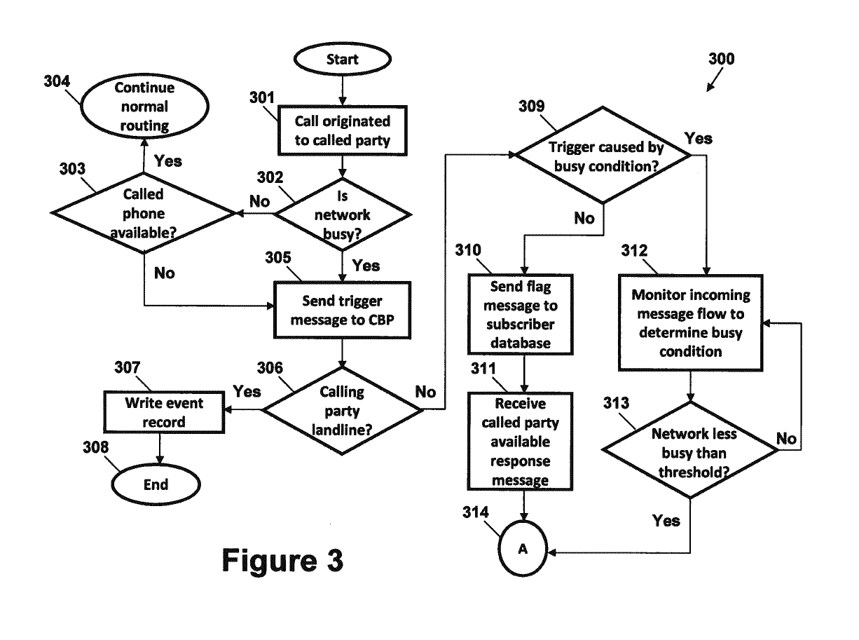

Turning now to FIG. 3, this figure shows an exemplary method 300 depicting how a call placed to a called party can utilize features of the call alert system disclosed herein according to an embodiment. At the start of the sequence a call is originated to a called party 301 and enters the serving network. The exemplary network described in relation to this figure may be a 3GPP network; however those skilled in the art will see how this sequence can be modified and adapted to other networks where phones or users encounter at least a portion of the network in a congestion mode or progress in and out of network coverage. At block 302 a determination may be made as to whether at least a portion of the network is busy. The network may programmed to determine this and apply special call handling to the inbound call attempt. The exemplary implementation utilizes a special code prefixed to the network busy treatment that triggers an INAP trigger thus alerting the CBP at block 305 if system encounters a network busy. If the network is available the network then determines if the called phone is available on the network at block 303. If the called phone is available the network then progress with normal call routing at block 304. If the called phone is not available due to being turned off or out of coverage the exemplary network is programmed to use send a trigger message to the CBP at block 305. The CBP then strips the prefix causing the INAP trigger and send the call routing number back to the network for the call to be routed.

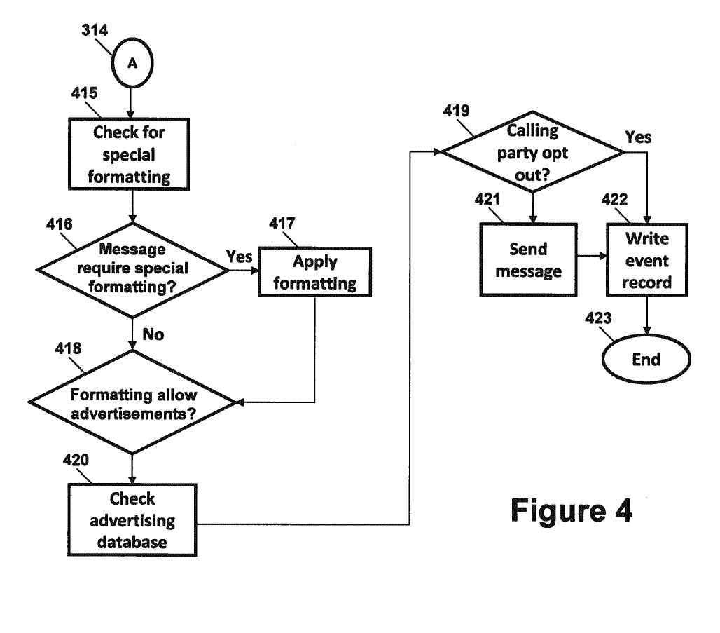

The system may then checks if the calling party is a landline phone at block 306 and not reachable via subsequent data message. In an exemplary system this is performed by a lookup of the phone number in a database showing the association of phone numbers to network (e.g., number portability database). If the calling party is a landline the CBP writes an event record at block 307 and the process is ended at block 308. If the calling party is not a landline the CBP determines if the message was triggered by a busy condition at block 9. The exemplary system uses different INAP prefixes for a busy condition trigger and a not available trigger. If the message was not caused by a busy condition, the CBP sends a message to the subscriber database at block 310 to set a flag that instructs the subscriber database to alert the CBP when the subscriber is again present on the network. In an exemplary implementation the subscriber database is a home location register HLR; however those skilled in the art can see how this subscriber database can be any method of alerting the CBP the phone is again available on the network. The CBP would then write a database record for this transaction and wait for a response from the subscriber database at block 311. When the response is received the system moves to the next phase at block 314, resuming at connection point A of FIG. 4.

Turning back to the trigger caused by busy condition at block 309, if the trigger was caused by a busy condition the CBP would write a database record for this transaction and then begin the process of monitoring the incoming data flow to the CBP or to multiple CBPs at block 312 to determine the extent of the network or network element loading. If the network loading is less than a predetermined threshold at block 313, the system moves to the next phase at block 314, resuming at connection point A of FIG. 4. If not, monitoring may continue at block 312.

The flow continues at point A, block 314, in FIG. 4. The CBP may check to determine if special formatting was required on the outgoing message at block 415. If it is determined at block 416 that special formatting is required, the CBP may apply the formatting rules to the message at block 417 and proceeds to block 418. If special formatting is not needed, the CBP applies the standard format template and proceeds to block 418. The CBP then determines if the formatting rules allow advertising at block 418. If the formatting rules allow advertising, the CBP may check an advertising database at block 420 using the data it has accumulated from the entire transaction to determine the appropriate advertising message to apply to the message. This accumulated data may include the last know location of the called party, network congestion, serving network provider of calling party, and/or a current location of the calling party (derived from subscriber database lookup for the calling party; e.g., send short message routing request message in the exemplary system). The system then determines whether the calling party has opted out of the missed call alert at block 419. If the calling party has opted out of the service, the CBP may write a call record at block 422 and the process is ended at block 423. If the calling party has not opted out of the missed call alert the CBP then sends a message at block 421 to the originally calling party, writes an event record at block 422, and ends the process at block 423.

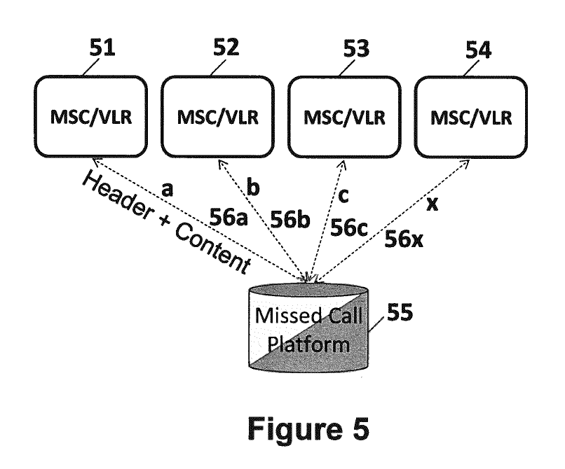

FIG. 5 illustrates an exemplary portion of a sample network demonstrating how missed call platform 55 may determine a network busy condition for the portion of the network serving the originally called party. FIG. 5 shows four mobile switching centers (also diagramed as visitor location registers in the exemplary implementation) 51, 52, 53, and 54. The missed call platform 55 receives messages 56a, 56b, 56c, and 56x from these platforms on links a, b, c, and x. The messages 56a, 56b, 56c, and 56x may contain header information that at least in part contains the identity or address of the originating network element. The identity or address can allow the missed call platform 55 to determine the MSC (e.g, 51, 52, 53, or 54) that sent an individual message (e.g., 56a, 56b, 56c, or 56x). This network element identity, along with knowledge of the network condition that triggered the message, allows the missed call platform 55 to determine an estimate of the loading of the particular network element identified. This loading information can be used in determining when to begin sending missed call alerts to the originally calling party. The loading information can also be used in determine how to throttle missed call alert messages to the originally calling parties.

It will be understood that the invention is not restricted to the illustrated embodiments and that various modifications can be made within the scope of the following claims.

Other modifications, features, and embodiments of the present invention will become evident to those of skill in the art. It should be appreciated, therefore, that many aspects of the present invention were described above by way of example only and are not intended as required or essential elements of the invention unless explicitly stated otherwise. It should also be understood that platforms or devices described in this disclosure, such as the CBP, can include distributed logic across numerous platforms networked together or working in conjunction with each other. It is also possible to utilize existing elements of the network to provide the functionality described in this disclosure without deviating from the intent of this disclosure. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. A method of notifying a caller that a recipient is available, the method comprising:
detecting a request from a caller device to place a call to a recipient mobile device;
determining that the recipient mobile device is not currently available;
storing a record of the incomplete call request;
determining that the recipient mobile device is available; and
transmitting a message to the caller device notifying the caller that the recipient device is available.

2. The method of claim 1, wherein determining that the recipient mobile device is not currently available comprises determining that the recipient mobile device is not currently available due to network congestion.

3. The method of claim 1, wherein the message comprises advertising.

4. The method of claim 3, wherein the advertising is based, at least in part, on a location of the caller device.

5. The method of claim 3, wherein the advertising is based, at least in part, on demographic information associated with the caller.

6. The method of claim 3, wherein the advertising is based, at least in part, on a serving network of the caller device.

7. The method of claim 1, wherein the message comprises an invitation to subscribe to a missed call alert service.

8. The method of claim 1, wherein the message comprises a user-selectable option to opt out of receiving future missed call alert messages.

9. The method of claim 1, wherein the message comprises content configured by the recipient.

10. The method of claim 9, wherein the message comprises an address for an alternative means of communicating with the recipient.

11. The method of claim 1, wherein determining that the recipient mobile device is not currently available is performed by an intelligent trigger.

12. The method of claim 11, wherein the intelligent network trigger is one of an Intelligent Network Application Part or a Customized Applications for Mobile networks Enhanced Logic.

13. An apparatus for providing call back alerts, the apparatus configured to:
receive a missed call event from a network device indicating that a recipient device is not currently available on the network, wherein the missed call event is generated by the network device when a call request is detected from a caller device;
monitor at least a portion of a network to detect when the recipient device becomes available on the network;
responsive to detecting when the recipient device becomes available on the network, transmit a message to the caller device indicating that the recipient device is available on the network.

14. The apparatus of claim 13, wherein the apparatus configured to monitor the at least a portion of the network comprises the apparatus configured to determine congestion on a network serving the recipient device.

15. The apparatus of claim 13, wherein the message comprises advertising.

16. The apparatus of claim 15, wherein the advertising is based, at least in part, on a location of the caller device.

17. The apparatus of claim 15, wherein the advertising is based, at least in part, on the serving network of the caller device.

18. The apparatus of claim 13, wherein the message comprises an invitation to subscribe to a missed call alert service.

19. The apparatus of claim 13, wherein the message comprises a user-selectable option to opt out of receiving future missed call alert messages.

20. The apparatus of claim 13, wherein the network device is an intelligent network trigger.
